(19) United States
(12) Patent Application Publication
(10) Pub. No.: US 2007/0095632 A1
(43) Pub. Date: May 3, 2007

(54) Agitating element for discharging poorly pourable bulk materials

(76) Inventors: Manfred Ottow, Berlin (DE); Robin Ottow, Basel (CH)

Correspondence Address: WILLIAM COLLARD;COLLARD & ROE, P.C., 1077 NORTHERN BOULEVARD, ROSLYN, NY, 11576, US

(21) Appl. No.: 11/591,932

(22) Filed: Nov. 2, 2006

(30) Foreign Application Priority Data
Nov. 2, 2005 (DE) 10 2005 052 621.7

(51) Int. Cl. B65G 13/02

(52) U.S. Cl. 198/780

(57) ABSTRACT

The invention pertains to a method and a device for discharging poorly pourable bulk materials such as, in particular, sawdust, splinters and wood chips from a receptacle. According to the invention, the poorly pourable bulk material in the receptacle is rendered free-flowing by means of a first helical agitating element and discharged from the receptacle by means of a second helical agitating element. In this case, it is particularly advantageous that the first helical agitating element and the second helical agitating element are mechanically coupled to one another such that only one drive is required for both agitating elements. The first agitating element consists of a shaft and a worm conveyor, and the second agitating element consists of a shaft and a spiral conveyor. The rotation of the worm conveyor causes the material situated in the outer region of the receptacle to be transported upward to the bulk material surface. This breaks up the bulk material. Material situated in the center flows downward due to the gravitational force. Consequently, a circulating motion of the bulk material takes place. The rotation of the spiral conveyor causes the broken up bulk material to be transported to the outlet opening at the receptacle bottom, at which it is discharged from the receptacle.

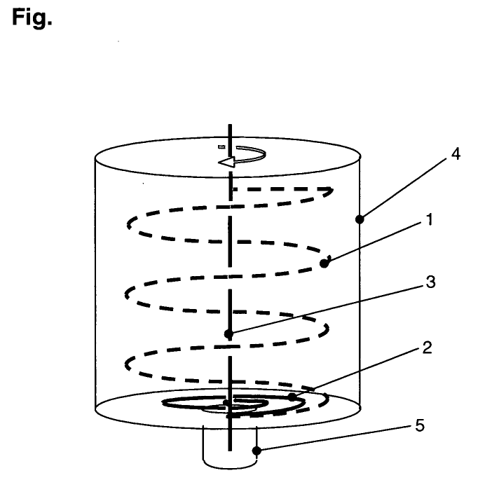

The invention pertains to a method and a device for discharging poorly pourable bulk materials such as, in particular, sawdust, splinters and wood chips from a receptacle.

In order to store bulk materials, receptacles are usually filled from the top and emptied through an outlet opening at the receptacle bottom. Bulk materials that interlock or have a poor pourability for different reasons are also not free-flowing at steep angles of repose and form material bridges over the outlet opening such that they cannot be discharged from the receptacle without additional measures.

DE 197 06 407 C1 describes a metering and discharging device for bulk materials, in which a stirrup-shaped agitator is arranged on a metering tube with a metering aperture. The bulk material flows into the metering tube through the metering aperture and is discharged from an outlet at the lower end of the metering tube. When processing poorly pourable bulk materials, the metering tube is set in rotation about the longitudinal axis such that the agitator breaks up the bulk material and the bulk material can be discharged through the metering aperture.

In this case, it is disadvantageous that the agitator is unable to separate individual bulk material particles from one another if they are more substantially entangled or interlocked. In such instances, the rotation of the agitator merely leads to a uniform rotational movement of the entire “block” of bulk material particles such that no bulk material is discharged from the receptacle.

DE 43 39 974 A1 discloses a device for metering powdery bulk materials, in which an agitating element in the form of a screw-shaft discharges the bulk material from a funnel-shaped reservoir. The quantity of bulk material to be metered can be varied in dependence on the rotational speed and the rotating direction of the screw-shaft. When using a screw-shaft with a right-handed thread, a clockwise rotation of the shaft results in a high metering accuracy at a low throughput and a counterclockwise rotation results in a lower metering accuracy at a higher throughput.

However, this device is only suitable for powdery bulk material because this type of bulk material cannot interlock and form clumps. Due to their rough and cleaved surfaces, poorly pourable materials such as, e.g., splinters and wood chips tend to interlock and form clumps such that the screw-shaft is blocked.

Consequently, the invention is based on the objective of making available a method and a device for ensuring the discharge of poorly pourable bulk materials from a receptacle, in which the disadvantages of the state of the art are eliminated.

With respect to the method, this objective is attained, according to the invention, with the characteristics disclosed in Claim 1, wherein the objective with respect to the device is attained, according to the invention, with the characteristics disclosed in Claim 3.

Claim 2 as well as Claims 4 to 8 define advantageous embodiments of the inventive solution disclosed in Claim 1 and Claim 3, respectively.

According to the invention, a poorly pourable bulk material is rendered free-flowing by means of a first helical agitating element and discharged from the receptacle by means of a second helical agitating element. In this case, it is particularly advantageous to mechanically couple the first helical agitating element and the second helical agitating element to one another such that only one drive is required for both agitating elements.

The first agitating element consists of a shaft and a worm conveyor, and the second agitating element consists of a shaft and a spiral conveyor. The shafts of the first and the second agitating element in fact consist of the same shaft such that the worm conveyor and the spiral conveyor are fixed on only one shaft. In this case, it is particularly advantageous that only one shaft is required and that the space requirement can be reduced accordingly.

The spiral conveyor is fixed on the shaft in such a way that it is positioned above the bottom of the receptacle, particularly directly above the bottom. The worm conveyor also begins in the region of the receptacle bottom and ends, in particular, at a point above the highest possible product filling level, at which it is connected to the shaft.

The rotation of the worm conveyor causes the material situated in the outer region of the receptacle to be transported upward to the bulk material surface. This breaks up the bulk material. The material situated in the center flows downward due to the gravitational force. Consequently, a circulating motion of the bulk material takes place.

The rotation of the spiral conveyor causes the broken up bulk material to be transported to the outlet opening at the receptacle bottom, at which it is discharged from the receptacle.

The inventive device is particularly suitable for emptying receptacles that are filled with sawdust and/or wood chips.

The invention is described in greater detail below with reference to an embodiment that is illustrated in FIGURE. The FIGURE schematically shows a specially shaped agitating element according to the invention.

According to the FIGURE, the agitating element consists of a shaft 3, a worm conveyor 1 and a spiral conveyor 2. The spiral conveyor 2 is fixed on the shaft 3 in such a way that it is positioned directly above the bottom of the receptacle 4. The worm conveyor 1 also begins at the receptacle bottom and ends at a point above the maximum product filling level, at which it is connected to the shaft 3.

The rotation of the worm conveyor 1 causes the bulk material situated in the outer region of the receptacle 4 to be transported upward to the bulk material surface. This breaks up the bulk material. The material situated in the center flows downward due to the gravitational force. Consequently, a circuiting motion of the bulk material takes place.

The rotation of the spiral conveyor causes the broken up bulk material to be transported to the outlet opening 5 at the bottom of the receptacle 4, at which it is discharged from the receptacle 4.

### LIST OF REFERENCE SYMBOLS

1 Worm conveyor
2 Spiral conveyor
3 Shaft
4 Receptacle
5 Outlet opening

1. A method for discharging poorly pourable bulk materials from a receptacle (4) with an outlet opening (5), wherein the bulk material is rendered free-flowing in the receptacle (4) by means of a first helical agitating element and discharged from the receptacle (4) by means of a second helical agitating element.

2. The method for discharging poorly pourable bulk materials according to claim 1, wherein the first helical agitating element and the second helical agitating element are mechanically coupled to one another.

3. A device for discharging poorly pourable bulk materials from a receptacle (4) with an opening (5), wherein the first agitating element is realized in the form of a worm conveyor (1) that is fixed on a shaft (3) and the rotation of which causes the bulk material situated in the outer region of the receptacle (4) to be transported upward to the bulk material surface, and in that the second agitating element is realized in the form of a spiral conveyor (2) that is fixed on a shaft and the rotation of which causes the broken up bulk material situated at the bottom of the receptacle (4) to be transported to the outlet opening (5).

4. The device for discharging poorly pourable bulk materials according to claim 3, wherein the worm conveyor (1) and the spiral conveyor (2) are fixed on the same shaft (3).

5. The device for discharging poorly pourable bulk materials according to claim 3, wherein the spiral conveyor (1) and the worm conveyor (2) begin in the region of the bottom of the receptacle (4).

6. The device for discharging poorly pourable bulk materials according claim 3, wherein the worm conveyor (1) ends above the highest possible product filling level and is connected to the shaft (3) at this location.

7. The device for discharging poorly pourable bulk materials according to at least one of claim 5, wherein the spiral conveyor (2) is fixed directly above the bottom of the receptacle (4).

8. The device for discharging poorly pourable bulk materials according to claim 3, wherein the poorly pourable bulk material consists of sawdust and/or splinters and/or wood chips.
